(19) United States
(12) Patent Application Publication
(10) Pub. No.: US 2025/0390924 A1
(43) Pub. Date: Dec. 25, 2025

(54) VEHICLE CATEGORIZATION AND USAGE FOR MODEL PREDICTIONS

(71) Applicant: Capital One Services, LLC, McLean, VA (US)

(72) Inventors: Vikas YADAV, Frisco, TX (US); Sreekanth CHINTHAGUNTA, Mckinney, TX (US)

(21) Appl. No.: 18/749,816

(22) Filed: Jun. 21, 2024

(51) Int. Cl. G06Q 30/0601; G06Q 40/03

(52) U.S. Cl. CPC G06Q 30/0629; G06Q 40/03

(57) ABSTRACT

In some implementations, a classification system may define multiple vehicle segments that each include a set of vehicle makes based on a set of vehicle make and model combinations. The classification system may define, based on the set of vehicle make and model combinations, multiple vehicle categories based on subsets of the vehicle make and model combinations with similar attributes, wherein the multiple vehicle categories are each associated with a unique identifier and a respective vehicle segment, of the multiple vehicle segments. The classification system may define multiple vehicle indexes that are each associated with a respective modeling profile. The classification system may store information that associates each of the multiple vehicle indexes with one or more of the multiple vehicle categories.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for vehicle categorization to assist model predictions. The system may include one or more memories and one or more processors communicatively coupled to the one or more memories. The one or more processors may be configured to obtain raw vehicle information that includes vehicle make and model combinations associated with one or more models. The one or more processors may be configured to define multiple vehicle segments that each include a set of vehicle makes based on the vehicle make and model combinations included in the raw vehicle information. The one or more processors may be configured to define, based on the vehicle make and model combinations included in the raw vehicle information, multiple vehicle categories based on subsets of the vehicle make and model combinations with similar attributes, wherein the multiple vehicle categories are each associated with a unique identifier and a respective vehicle segment, of the multiple vehicle segments. The one or more processors may be configured to define multiple vehicle indexes that are each associated with a risk profile. The one or more processors may be configured to store, in a data repository accessible to a system that uses the one or more models to generate one or more predictions based on an input vehicle make and model combination, information that associates each of the multiple vehicle indexes with one or more of the multiple vehicle categories.

Some implementations described herein relate to a method for vehicle categorization to assist model predictions. The method may include defining, by a classification system, multiple vehicle segments that each include a set of vehicle makes based on a set of vehicle make and model combinations. The method may include defining, based on the set of vehicle make and model combinations, multiple vehicle categories based on subsets of the vehicle make and model combinations with similar attributes, wherein the multiple vehicle categories are each associated with a unique identifier and a respective vehicle segment, of the multiple vehicle segments. The method may include defining, by the classification system, multiple vehicle indexes that are each associated with a respective modeling profile. The method may include storing, by the classification system, information that associates each of the multiple vehicle indexes with one or more of the multiple vehicle categories.

Some implementations described herein relate to a non-transitory computer-readable medium that stores a set of instructions. The set of instructions, when executed by one or more processors of a modeling system, may cause the modeling system to receive a request to generate one or more predictions in a context related to a vehicle make and model combination, wherein the vehicle make and model combination is associated with a vehicle category. The set of instructions, when executed by one or more processors of the modeling system, may cause the modeling system to determine, among multiple vehicle indexes that are each associated with a respective modeling profile, a vehicle index associated with the vehicle make and model combination associated based on the vehicle category associated with the vehicle make and model combination. The set of instructions, when executed by one or more processors of the modeling system, may cause the modeling system to provide, to a predictive model, a set of inputs that includes the vehicle index associated with the vehicle make and model combination. The set of instructions, when executed by one or more processors of the modeling system, may cause the modeling system to obtain, from the predictive model, an output that includes the one or more predictions based on the set of inputs that includes the vehicle index associated with the vehicle make and model combination.

### BRIEF DESCRIPTION OF THE DRAWINGS

FIGS. 1A-1C are diagrams of an example associated with vehicle categorization and usage for model predictions, in accordance with some embodiments of the present disclosure.

FIG. 2 is a diagram illustrating an example of training and using a machine learning model in connection with vehicle categorization, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with vehicle categorization and usage for model predictions, in accordance with some embodiments of the present disclosure.

FIGS. 5-6 are flowcharts of example processes associated with vehicle categorization and usage for model predictions, in accordance with some embodiments of the present disclosure.

### DETAILED DESCRIPTION

The following detailed description of example implementations refers to the accompanying drawings. The same reference numbers in different drawings may identify the same or similar elements.

There are various modeling and/or data analytics use cases that may use information related to a vehicle make and model combination as an input. For example, information related to a vehicle make and model combination may be used for predictive vehicle maintenance, where historical maintenance data for vehicle make and model combinations is analyzed to predict when certain components are likely to fail or require maintenance based on usage patterns, environmental factors, and/or known issues with specific make and model combinations. In another example, vehicle make and model information may be used in risk assessment models to predict the likelihood of costly incidents, such as accidents and/or theft, which may help insurers to determine appropriate premiums and coverage levels. In still other examples, vehicle make and model information may be used to identify trends in fuel efficiency (which may be useful for consumers interested in purchasing a fuel-efficient vehicle and/or manufacturers considering design changes or technology upgrades to improve fuel efficiency), to forecast future demand patterns (which may inform vehicle production planning and/or inventory management), and/or to optimize vehicle pricing and/or financing terms, among other examples.

However, existing techniques to represent information related to vehicle make and model combinations suffer from various drawbacks. For example, vehicle make and model data is typically represented in a raw form, which makes the vehicle make and model data difficult to consume and/or limits the predictive capabilities of the modeling and/or data analytics use case relying upon the raw vehicle make and model data. For example, raw vehicle make and model data may include a make string field, a model string field, and a year number field, which provides limited information about the vehicle make and model combination and lacks information that may be relevant to evaluating the vehicle make and model combination in a broader context. Furthermore, feeding every vehicle make and model combination to a model or data analytics system is challenging because there are thousands of different vehicle make and model combinations, vehicle makes and/or models are frequently introduced, discontinued, and/or redesigned, the vehicle makes and/or model that are available in the market and/or in use on roadways can vary significantly in different regions (e.g., the United States, Europe, and/or Japan, among other examples), and different modeling and/or data analytics use cases may operate on data that is structured using different schemas.

Some implementations described herein relate to a vehicle categorization or classification system that may create and maintain a lookup table or other suitable data structure in which various indexes are each associated with one or more vehicle categories that have similar profiles in a context related to modeling or data analytics use cases (e.g., similar risks, similar values, similar styles, similar market segments, and/or other similar attributes). For example, in some implementations, the classification system may derive the indexes using a categorization process in which known vehicle makes are divided into multiple segments (e.g., luxury and non-luxury, although additional and/other segments may be defined), and each segment may be associated with various categories for the different vehicle models that each vehicle manufacturer offers (e.g., sedans, minivans, sports cars, and/or pickup trucks, among other examples). Accordingly, the categorical vehicle indexes may be used as an input to any suitable modeling and/or data analytics use case that can take a vehicle make and model combination as an input. For example, given a vehicle associated with a specific make and model combination, a modeling system may determine the applicable vehicle segment and vehicle category, which may be used to retrieve a corresponding index for the vehicle. The index can then be used as an input to the model to represent the properties of the vehicle.

Accordingly, some implementations described herein may derive or otherwise create a vehicle categorization scheme from vehicle make and model combinations that are available or in-use in one or more markets, which makes the vehicle make and model information more usable in modeling and/or data analytics use cases. For example, as described herein, the classification system may create the vehicle categorization scheme such that any vehicle make and model combination can be mapped to a specific vehicle category and name grouping, and the classification system may be configured to update the vehicle category mapping when vehicle make and model combinations are newly introduced or redesigned. For example, each vehicle category may be associated with a unique index or other identifier that can be associated with one or more vehicle make and model combinations, whereby the unique index or other identifier associated with a vehicle make and model can be used as an input in any modeling or data analytics use case associated with the vehicle make and model (e.g., a credit model used to improve the manner in which a vehicle used as collateral affects risk). Furthermore, by using unique indexes or other identifiers associated with different vehicle categories as a variable, the output associated with a modeling or data analytics use case may be more accurate and/or offer improved predictive power (e.g., an area under curve (AUC) metric, an R-squared metric, and/or a root mean squared error (RMSE) metric, among other examples).

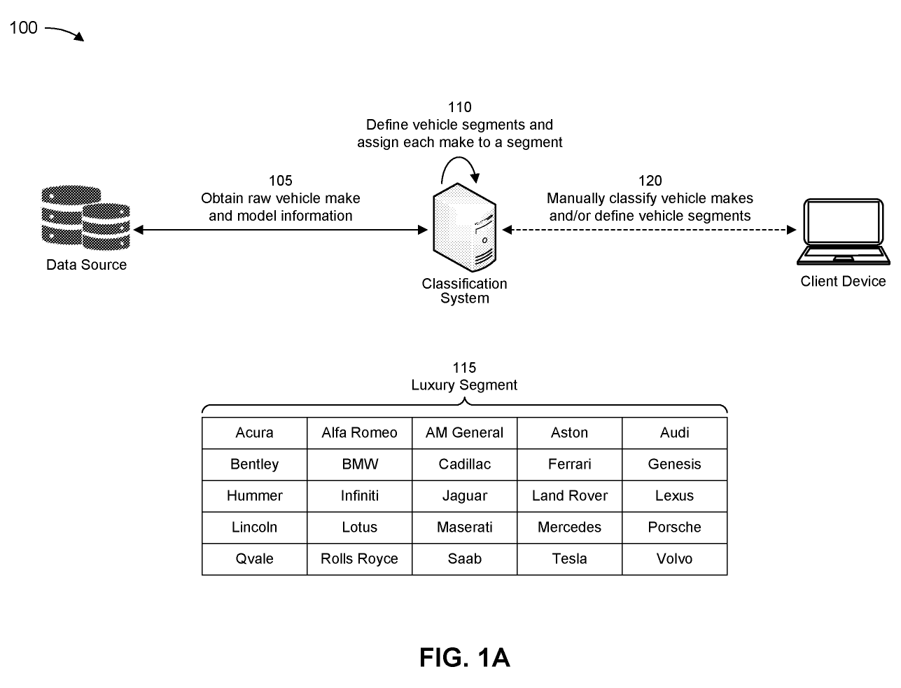

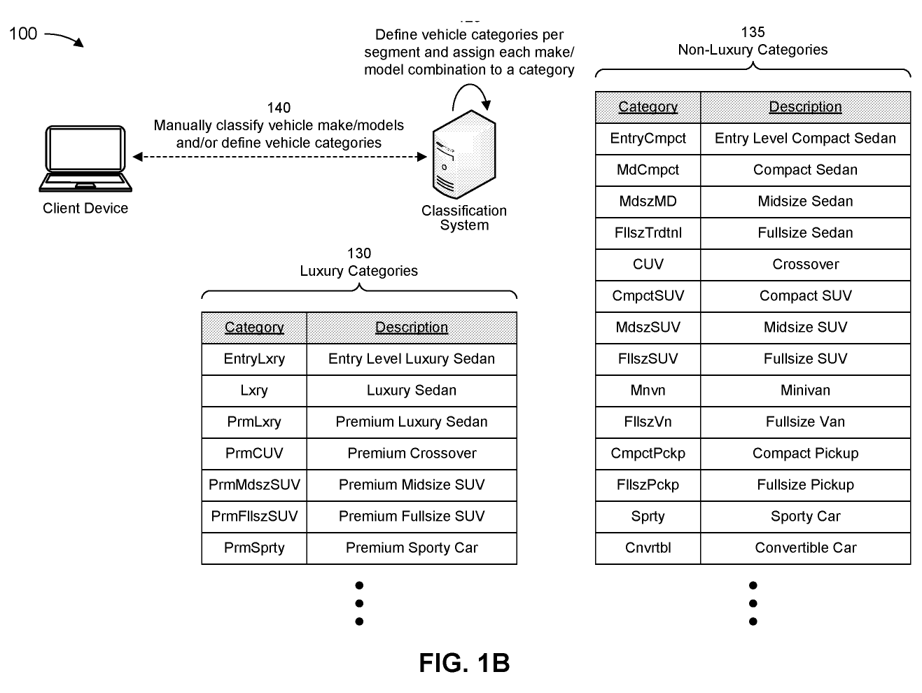

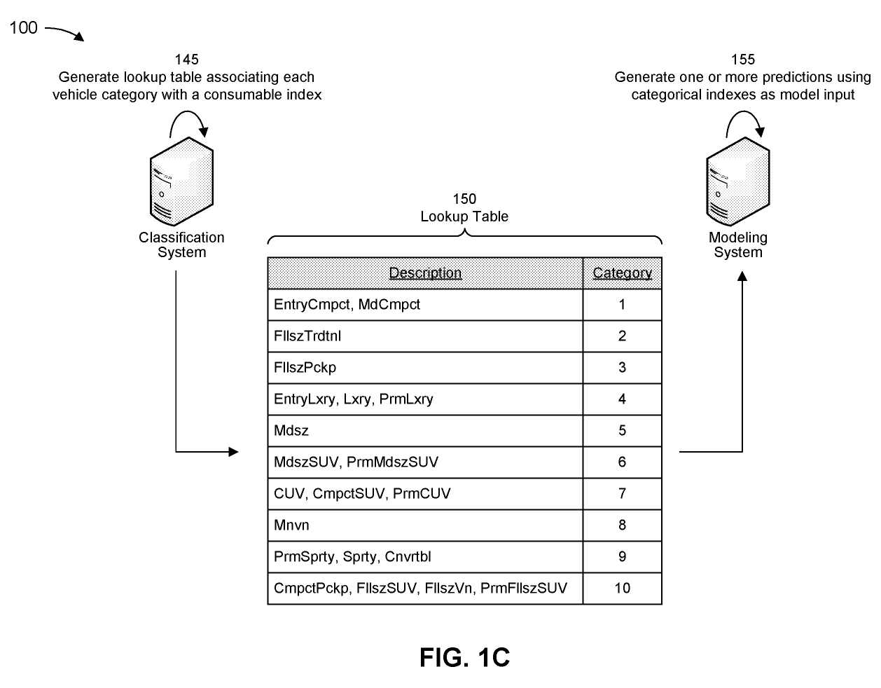

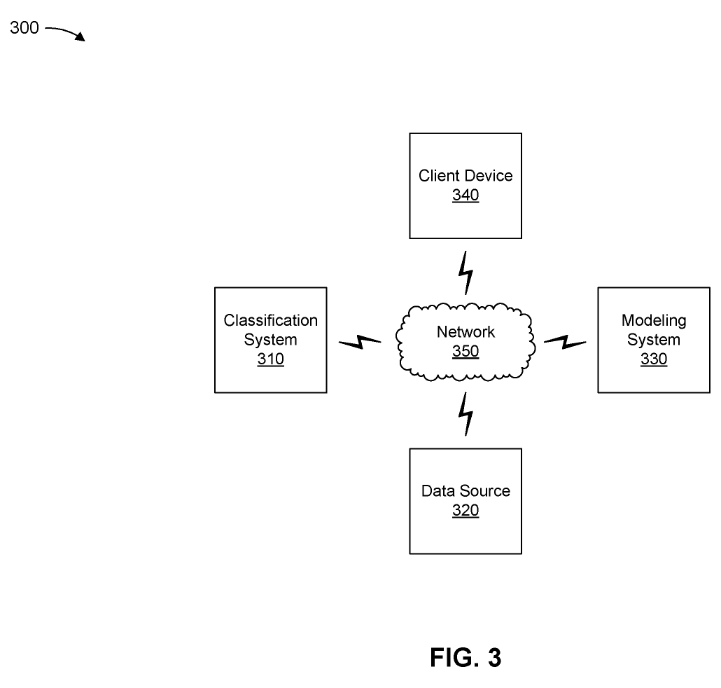

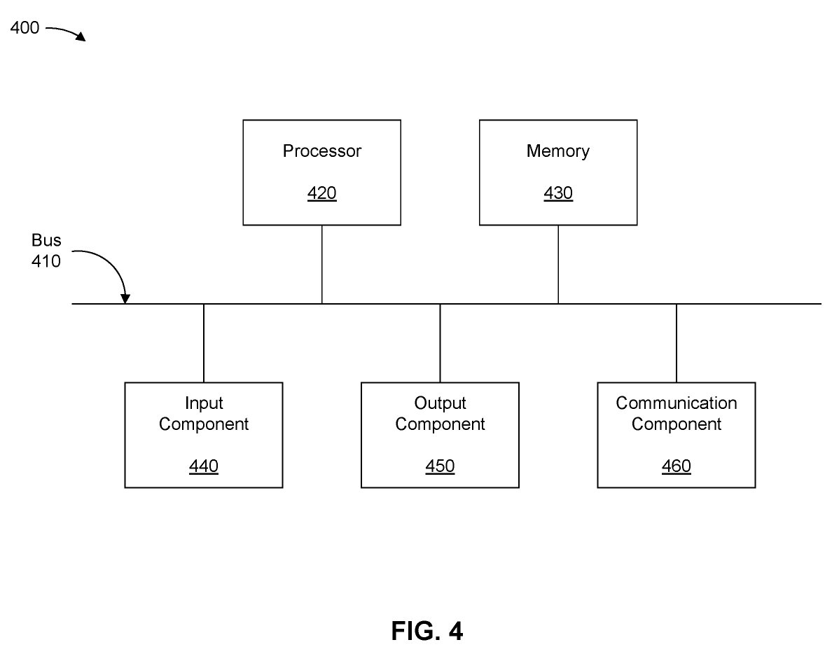

FIGS. 1A-1C are diagrams of an example 100 associated with vehicle categorization and usage for model predictions. As shown in FIGS. 1A-1C, example 100 includes a classification system, a data source, a client device, and a modeling system. The classification system, the data source, the client device, and the modeling system are described in more detail in connection with FIG. 3 and FIG. 4.

As shown in FIG. 1A, and by reference number 105, the classification system may obtain raw vehicle make and model information from a data source. For example, in some implementations, the data source may store one or more datasets that include detailed information related to motor vehicles that are available in one or more geographic markets. In some implementations, each record in the one or more datasets may include a set of fields associated with a vehicle make and model combination, including at least a make field and a model field, and the dataset may include a record for each known vehicle make and model combination (e.g., records associated with the Acura make may include records for models that include the Acura CL, ILX, Integra, Legend, and MDX, among others, records associated with the Ferrari make may include records for models that include the 430 Scuderia, 458 Italia, and 458 Spider, among others, and so on for each vehicle make). In some implementations, the one or more datasets may include additional fields associated with each record, such as a year field, a body field (e.g., sport utility vehicle (SUV), hatchback, sedan, coupe, minivan, and so on), a trim (e.g., for vehicle models that are offered in different trim levels), a region (e.g., North America, Europe, Asia Pacific, Latin America, Middle East and Africa, or the like), and/or one or more specification fields, among other examples. In some implementations, the datasets that include the raw vehicle make and model information may be associated with any suitable data format, such as a JavaScript Object Notation (JSON) format, a comma-separated values (CSV) format, a spreadsheet (e.g., XLS) format, and/or a Structured Query Language (SQL) format.

Accordingly, as described herein, the raw vehicle make and model information obtained from the data source may generally include one or more comprehensive datasets that include records for all known vehicle makes (or manufacturers), and all vehicle models associated with each vehicle make. Furthermore, the datasets may include information related to one or more geographic regions (e.g., North American, European, Australian, and/or other markets) where each vehicle make and model combination is available or was available in the past, and may cover any suitable time range (e.g., including one or more future years, when information related to upcoming vehicle models have been announced). In some implementations, the classification system may then process the raw vehicle make and model information to derive or otherwise create a set of vehicle categories that are consumable in one or more modeling or data analytics use cases. Furthermore, in some implementations, the classification system may filter the raw vehicle make and model information prior to deriving or creating the set of vehicle categories. For example, in some implementations, the classification system may filter the raw vehicle make and model information to exclude or remove vehicle make and model combinations that may have little or no relevance to an applicable modeling or data analytics use case. For example, the raw vehicle make and model information may be filtered to remove vehicle make and model combinations that are not available in a target geographic region (e.g., may remove vehicle make and model combinations that are only available in the European market when the modeling or data analytics use case relates to the North American market). Additionally, or alternatively, the raw vehicle make and model information may be filtered to remove vehicle make and model combinations that have not been available within a threshold time period (e.g., were manufactured in a year prior to a threshold, to exclude vehicles that are no longer available to purchase, or only rarely available to purchase as a used vehicle). In this way, the raw vehicle make and model information may be filtered to include only a set of vehicle make and model combinations that are relevant to a modeling or data analytics use case (e.g., models available in the North American market within the last 10 years, models available in the North American market and/or the European market within the last 20 years, or the like).

As further shown in FIG. 1A, and by reference number 110, the classification system may define multiple vehicle segments, and may assign each vehicle make to a vehicle segment (e.g., by executing one or more automated scripts to analyze the raw vehicle make and model information according to one or more rules). For example, in some implementations, the vehicle segments may be defined to segregate or otherwise partition the (e.g., filtered or unfiltered) raw vehicle make and model information into different segments that are associated with similar profiles in a context related to a modeling or data analytics use case. For example, when the modeling or data analytics use case relates to modeling a credit risk or a deal structure risk for vehicle financing applications, determining account valuations for outstanding vehicle loans, modeling a front-end limit (e.g., a loan-to-value ratio or debt-to-income ratio) for vehicle financing applications, or the like, the vehicle segments may be defined according to vehicle makes and/or models that have a relatively higher or lower probability of a loan default, a relatively higher or lower probability of prepayments, relative depreciation rates and associated impacts on metrics such as a net present value, or the like.

For example, as shown in FIG. 1A, and by reference number 115, the vehicle segments that are defined by the classification may include a luxury segment (e.g., based on one or more data models indicating that borrowers that select luxury automobiles have an overall higher probability of making prepayments on a vehicle loan, such that vehicles in a luxury segment have a higher probability of being repaid, or a lower probability of profitability for a lender due to prepayments reducing the amount of interest collected over the life of the loan). As further shown in FIG. 1A, the classification system may analyze the raw vehicle make and model information, and may identify a set of vehicle makes to the luxury segment (e.g., Acura, Alfa Romeo, AM General, . . . , Saab, Tesla, Volvo). In one example, the vehicle segments may include the luxury segment and a non-luxury segment, and each vehicle make that is not assigned to the luxury segment may be assigned to the non-luxury segment. Additionally, or alternatively, the classification system may define additional vehicle segments, or vehicle segments at a higher granularity, such as partitioning the luxury segment into an entry-level luxury segment (e.g., including makes such as Acura, Lexus, BMW, or the like) and a high-end luxury segment (e.g., including makes such as Ferrari, Lotus, Rolls Royce, or the like). In another example, the non-luxury segment may include a standard segment (e.g., including makes such as Toyota, Honda, or the like) and an economy segment (e.g., including makes such as Kia, Subaru, Hyundai, or the like, based on one or more data models indicating that borrowers that select economy automobiles have an overall lower probability of defaulting, such that vehicles in an economy segment pose a lower credit risk and/or a higher probability of profitability based on the amount of interest collected over the life of the loan).

Furthermore, although some examples described herein relate to vehicle segments that may be used to segregate different vehicle makes, the vehicle segments may be defined according to other suitable criteria, where a particular vehicle make may be associated with vehicle models that are assigned to different segments. For example, in some implementations, the vehicle segments may include a fuel-efficient segment (e.g., including electric and hybrid vehicle models), a fuel-inefficient segment (e.g., including non-electric and non-hybrid SUV, truck, and other vehicle models that tend to have low fuel efficiencies), and a standard fuel efficiency segment (e.g., including all vehicle models that are neither fuel-efficient nor fuel-inefficient). In other examples, the vehicle segments may be defined according to body styles, market segments, legal classifications, geographic markets, and/or other segment criteria. For example, in some implementations, the vehicle segments may be defined according to criteria specified by the European New Car Assessment Programme (NCAP), criteria defining European car segments, criteria defining U.S. Environmental Protection Agency (EPA) size classes, and/or criteria defining other suitable vehicle segments, which may include various degrees of overlap. For example, Euro car segments include A-segment mini cars and B-segment small cars, which correspond to a supermini Euro NCAP class, to minicompact and subcompact U.S. EPA size classes, and to Kei cars in Japan. In another example, the segments may include S-segment sports coupes, which correspond to a roadster sports Euro NCAP class, to a two-seater size class under U.S. EPA standards, and to vehicles commonly known as supercars, convertibles, roadsters, or sports cars. Accordingly, as described herein, the multiple vehicle segments may be defined by the classification system based on any suitable criteria, and not necessarily according to criteria that group all models associated with a particular make within the same segment. Furthermore, as shown by reference number 120, a user of a client device may provide one or more inputs to the classification system to manually classify vehicle makes (or make and model combinations) to certain vehicle segments and/or to define or revise the vehicle segments derived by the classification system (e.g., to address unique situations, such as a vehicle make and/or model satisfying criteria associated with multiple segments, and/or to create one or more segments, delete one or more segments, or the like).

As shown in FIG. 1B, and by reference number 125, the classification system may define a set of vehicle categories within each segment, and may assign each vehicle make and model combination to a particular vehicle category within a particular vehicle segment (e.g., by executing one or more automated scripts to analyze the raw vehicle make and model information according to one or more rules). For example, as shown by reference number 130 in FIG. 1B, the classification system may define, within a luxury segment, categories that include an entry level luxury sedan, a luxury sedan, a premium luxury sedan, a premium crossover, a premium midsize SUV, a premium fullsize SUV, and/or a premium sporty car, among other examples. Accordingly, in some implementations, the classification system may assign each vehicle make and model combination associated with the luxury segment to a particular category within the luxury segment. Similarly, as shown by reference number 135 in FIG. 1B, the classification system may define, within a non-luxury segment, categories that include an entry level compact sedan, a compact sedan, a midsize sedan, a fullsize sedan, a crossover, or the like. Accordingly, the classification system may similarly assign each vehicle make and model combination associated with the non-luxury segment to a particular category within the non-luxury segment. Furthermore, although FIG. 1B illustrates an example where the vehicle categories are defined within luxury and non-luxury segments, the vehicle segments may be defined according to other suitable criteria, and the categories within each segment may be defined accordingly. For example, a fuel-efficient segment may include categories for electric vehicles, hybrid vehicles, clean diesel vehicles, gas-powered vehicles that achieve a number of miles per gallon that exceeds a threshold, or the like. In some implementations, the vehicle categories associated with each segment may be determined based on one or more fields included in the raw vehicle make and model information (e.g., indicating a body style, fuel class, or other specifications associated with each vehicle make and model combination), based on information on manufacturer websites, and/or based on consumer reports or market research, among other examples. As further shown in FIG. 1B, each vehicle category may be associated with a string or variable name that encodes both the segment and the category associated with a vehicle make and model combination (e.g., the convertible category within the non-luxury segment may be represented according to the variable name “Cnvrtbl” or another suitable string or parameter, and a premium sporty category within the luxury segment may be represented according to the variable name “PrmSprty” or another suitable string or parameter, among other examples). Accordingly, as described herein, each vehicle make and model combination to be classified may be assigned to one segment, of the multiple vehicle segments, and to one category, of the multiple categories within the associated vehicle segment. Furthermore, as shown by reference number 140, a user of the client device may provide one or more inputs to the classification system to manually classify one or more vehicle make and model combinations to appropriate vehicle categories and/or to define or revise the vehicle categories.

As shown in FIG. 1C, and by reference number 145, the classification system may generate a lookup table (or other suitable data structure) that associates each vehicle category with a consumable index that can be used as an input for any suitable modeling or data analytics use case, and the lookup table or other data structure may be stored in a data repository accessible to a modeling system or other system that may use the consumable indexes as an input for a modeling or data analytics use case. For example, as shown by reference number 150, each index may be represented as a number or another unique value associated with a set of one or more vehicle categories that have a similar profile in a context of the applicable modeling or data analytics use cases. For example, in modeling or data analytics use cases related to loans or loan applications in which a vehicle associated with a vehicle make and model combination is used as collateral, each index may correspond to a set of vehicle categories that have a similar risk profile (e.g. depreciation pattern, probability of default, probability of profitability, or the like). Furthermore, as shown, an index may include categories that are associated with different segments (e.g., in FIG. 1C, the index “6” is associated with midsize SUVs in the non-luxury segment and premium midsize SUVs in the luxury segment). Accordingly, as shown by reference number 155, a modeling system may generate one or more predictions (or perform one or more data analytics functions) that use the categorical indexes as an input (e.g., given one or more vehicle make and model combinations). For example, when processing a loan application in which a particular vehicle make and model combination is to be used as collateral (e.g., the loan application is to finance a vehicle associated with the vehicle make and model combination), the modeling system may determine the vehicle segment in which the vehicle make and model combination is classified, and the category within the segment in which the vehicle make and model combination is classified. Accordingly, as described herein, the category may correspond to one of the categories in the lookup table, and the modeling system may use the corresponding index as an input to model the relevant attributes of the vehicle make and model combination.

In some implementations, the classification system may perform an update process to update the lookup table mapping the various vehicle categories to corresponding indexes. For example, in some implementations, the classification system may perform recurring updates at periodic intervals (e.g., quarterly, annually, dynamically, or in an event-triggered manner, such as when new vehicle models are announced). In some implementations, the updates may be performed by executing one or more automated scripts and/or based on one or more manual inputs that are received from the client device, which may define new segments, define new categories, remove deprecated categories, define segments and/or categories at coarser or finer levels of granularity, or the like. Additionally, or alternatively, the recurring updates may be performed to update the segments and/or categories associated with vehicle make and model combinations that are not covered by an existing mapping and/or based on changes to the risk profile or other attributes associated with one or more vehicle make and model combinations. Accordingly, the lookup table or other data structure may be updated as-needed such that the modeling system can obtain up-to-date information for any suitable modeling or data analytics use case in which a vehicle make and model combination is a relevant input.

As indicated above, FIGS. 1A-1C are provided as an example. Other examples may differ from what is described with regard to FIGS. 1A-1C.

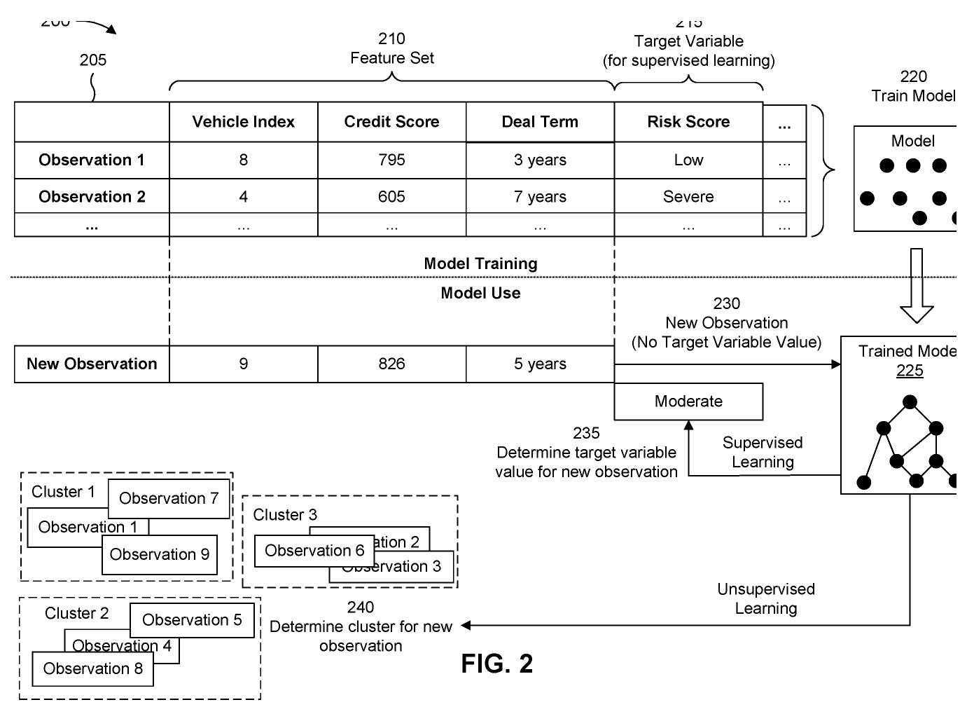

FIG. 2 is a diagram illustrating an example 200 of training and using a machine learning model in connection with vehicle categorization. The machine learning model training and usage described herein may be performed using a machine learning system. The machine learning system may include or may be included in a computing device, a server, a cloud computing environment, or the like, such as the classification system and/or the modeling system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the classification system, the modeling system, and/or other suitable sources, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the classification system, the modeling system, and/or other suitable sources. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations (e.g., related to a consumer loan application to purchase or lease a vehicle associated with a particular make and model combination) may include a first feature of vehicle index, a second feature of credit score, a third feature of deal term, and so on. As shown, for a first observation, the first feature may have a value of 8 (e.g., corresponding to a minivan category associated with the vehicle make and model), the second feature may have a value of 795 (e.g., a credit score of the consumer applying for the loan), the third feature may have a value of 3 years (e.g., a length of the loan that the consumer is applying for), and so on. These features and feature values are provided as examples, and may differ in other examples. For example, the feature set may include one or more of the following features: income, vehicle depreciation, interest rate, and/or loan-to-value ratio, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is risk score, which has a value of low for the first observation (e.g., based on the consumer having a relatively high credit score, and applying for a relatively short-term loan to purchase or lease a minivan, which may be associated with a low default rate).

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical records associated with various loans in which vehicles were used as collateral, including the makes and models of the vehicles that were used as collateral, the credit scores of the loan applicants, the length and/or interest rate of the loans, whether the loans were pre-paid, whether any defaults occurred, whether the loans were profitable (e.g., whether interest collected over the life of the loan exceeded costs of issuing the loans), or the like.

As shown by reference number 230, the machine learning system may apply the trained machine learning model 225 to a new observation, such as by receiving a new observation and inputting the new observation to the trained machine learning model 225. As shown, the new observation may include a first feature of a vehicle index of “9”, corresponding to a vehicle make and model combination classified as a premium sports car, a non-luxury sports car, or a non-luxury convertible, a second feature of a credit score of 826 (e.g., a very high credit score), a third feature of a 5-year loan term, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “moderate” for the target variable of a risk score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to reduce the loan term or request a larger down-payment. The first automated action may include, for example, increasing the interest rate for a loan application.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., loan applications associated with a moderate risk), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include information related to an approved loan over time, such as whether the loan eventually returned a profit, whether the borrower made payments on time, the depreciation pattern of the vehicle make and model that was used as collateral, or the like.

In this way, the machine learning system may apply a rigorous and automated process to generate one or more predictions related to a modeling and/or data analytics use case based on a categorical index associated with a vehicle make and model combination relevant to the modeling and/or data analytics use case. The machine learning system may enable recognition and/or identification of tens, hundreds, thousands, or millions of features and/or feature values for tens, hundreds, thousands, or millions of observations, thereby increasing accuracy and consistency and reducing delay associated with generating the one more predictions relative to requiring computing resources to be allocated for tens, hundreds, or thousands of operators to manually arrive at the one or more predictions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a classification system 310, a data source 320, a modeling system 330, a client device 340, and a network 350. Devices of environment 300 may interconnect via wired connections, wireless connections, or a combination of wired and wireless connections.

The classification system 310 may include one or more devices capable of receiving, generating, storing, processing, providing, and/or routing information associated with vehicle categorization and usage for model predictions, as described elsewhere herein. The classification system 310 may include a communication device and/or a computing device. For example, the classification system 310 may include a server, such as an application server, a client server, a web server, a database server, a host server, a proxy server, a virtual server (e.g., executing on computing hardware), or a server in a cloud computing system. In some implementations, the classification system 310 may include computing hardware used in a cloud computing environment.

The data source 320 may include one or more devices capable of receiving, generating, storing, processing, and/or providing information associated with vehicle categorization and usage for model predictions, as described elsewhere herein. The data source 320 may include a communication device and/or a computing device. For example, the data source 320 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 320 may communicate with one or more other devices of environment 300, as described elsewhere herein.

The modeling system 330 may include one or more devices capable of receiving, generating, storing, processing, providing, and/or routing information associated with vehicle categorization and usage for model predictions, as described elsewhere herein. The modeling system 330 may include a communication device and/or a computing device. For example, the modeling system 330 may include a server, such as an application server, a client server, a web server, a database server, a host server, a proxy server, a virtual server (e.g., executing on computing hardware), or a server in a cloud computing system. In some implementations, the modeling system 330 may include computing hardware used in a cloud computing environment.

The client device 340 may include one or more devices capable of receiving, generating, storing, processing, and/or providing information associated with vehicle categorization and usage for model predictions, as described elsewhere herein. The client device 340 may include a communication device and/or a computing device. For example, the client device 340 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with vehicle categorization and usage for model predictions. The device 400 may correspond to the classification system 310, the data source 320, the modeling system 330, and/or the client device 340. In some implementations, the classification system 310, the data source 320, the modeling system 330, and/or the client device 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

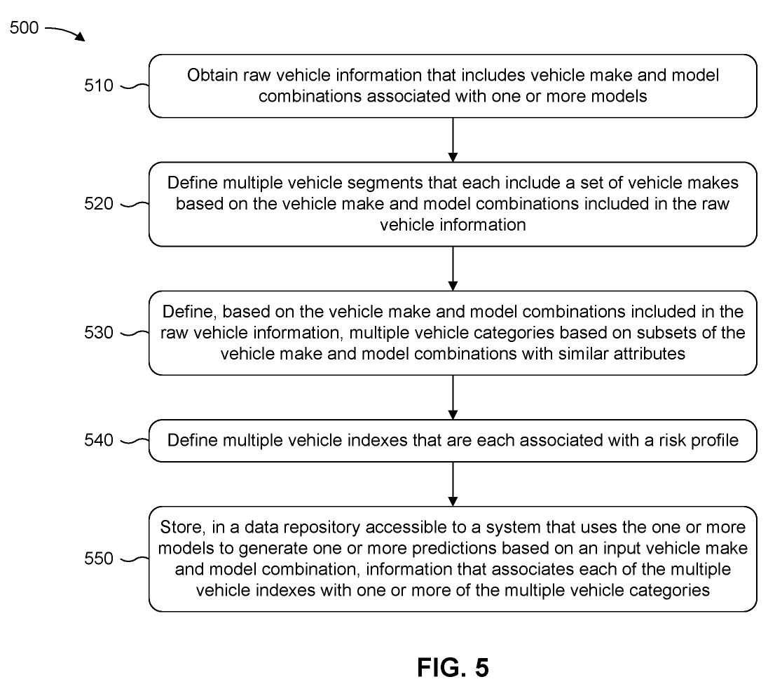

FIG. 5 is a flowchart of an example process 500 associated with vehicle categorization and usage for model predictions. In some implementations, one or more process blocks of FIG. 5 may be performed by the classification system 310. In some implementations, one or more process blocks of FIG. 5 may be performed by another device or a group of devices separate from or including the classification system 310, such as the data source 320, the modeling system 330, and/or the client device 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining raw vehicle information that includes vehicle make and model combinations associated with one or more models (block 510). For example, the classification system 310 (e.g., using processor 420 and/or memory 430) may obtain raw vehicle information that includes vehicle make and model combinations associated with one or more models, as described above in connection with reference number 105 of FIG. 1A. As an example, the raw vehicle information may include one or more datasets that include details related to vehicle makes and models (e.g., with fields for at least a make and a model, and optionally further including fields for a year, geographic market, body style, engine type, trim level, and/or fuel type, among other examples).

As further shown in FIG. 5, process 500 may include defining multiple vehicle segments that each include a set of vehicle makes based on the vehicle make and model combinations included in the raw vehicle information (block 520). For example, the classification system 310 (e.g., using processor 420 and/or memory 430) may define multiple vehicle segments that each include a set of vehicle makes based on the vehicle make and model combinations included in the raw vehicle information, as described above in connection with reference numbers 110, 115, and 120 of FIG. 1A. As an example, the classification system may define a luxury segment that includes a set of vehicle makes that are associated with luxury vehicles, and a non-luxury segment that includes a set of vehicle makes that are associated with non-luxury vehicles.

As further shown in FIG. 5, process 500 may include defining, based on the vehicle make and model combinations included in the raw vehicle information, multiple vehicle categories based on subsets of the vehicle make and model combinations with similar attributes (block 530). For example, the classification system 310 (e.g., using processor 420 and/or memory 430) may define, based on the vehicle make and model combinations included in the raw vehicle information, multiple vehicle categories based on subsets of the vehicle make and model combinations with similar attributes, as described above in connection with reference number 125, 130, 135, and 140 of FIG. 1B. As an example, the luxury segment may include various categories associated with subsets of the luxury vehicle makes that have similar attributes, such as SUVs, sedans, sports cars, or the like, and the non-luxury segment may include various categories associated with subsets of the non-luxury vehicle makes that have similar attributes, such as compact sedans, minivans, compact pickups, or the like. In some implementations, the multiple vehicle categories are each associated with a unique identifier and a respective vehicle segment, of the multiple vehicle segments. As an example, each vehicle category may be associated with a string, a variable name, or another suitable parameter that uniquely corresponds to the vehicle category, such that the segment and category associated with a vehicle make and model combination can be determined from the associated unique identifier.

As further shown in FIG. 5, process 500 may include defining multiple vehicle indexes that are each associated with a risk profile (block 540). For example, the classification system 310 (e.g., using processor 420 and/or memory 430) may define multiple vehicle indexes that are each associated with a risk profile, as described above in connection with reference numbers 145 and 150 of FIG. 1C. As an example, various indexes may be defined in a lookup table, with each index mapped to one or more vehicle categories (e.g., within the same segment or spanning multiple segments) that have similar profiles in a context related to a modeling or data analytics use case, such as risk profiles related to loans or loan applications that use a vehicle as collateral.

As further shown in FIG. 5, process 500 may include storing, in a data repository accessible to a system that uses the one or more models to generate one or more predictions based on an input vehicle make and model combination, information that associates each of the multiple vehicle indexes with one or more of the multiple vehicle categories (block 550). For example, the classification system 310 (e.g., using processor 420 and/or memory 430) may store, in a data repository accessible to a system that uses the one or more models to generate one or more predictions based on an input vehicle make and model combination, information that associates each of the multiple vehicle indexes with one or more of the multiple vehicle categories, as described above in connection with reference numbers 145 and 150 of FIG. 1C. As an example, the lookup table may be stored in a data repository accessible to a modeling system that uses the consumable indexes as an input in a modeling or data analytics use case related to loans or loan applications in which vehicles are used as collateral.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

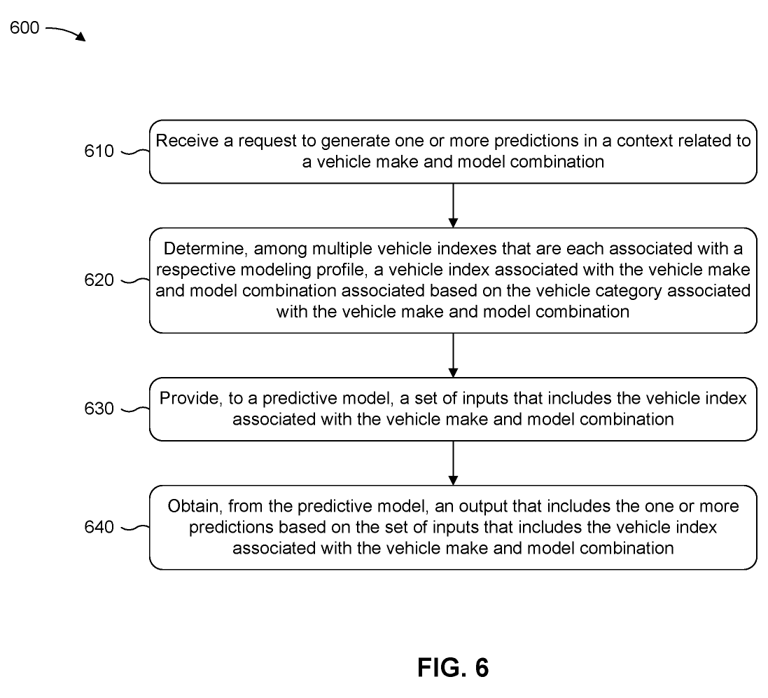

FIG. 6 is a flowchart of an example process 600 associated with vehicle categorization and usage for model predictions. In some implementations, one or more process blocks of FIG. 6 may be performed by the modeling system 330. In some implementations, one or more process blocks of FIG. 6 may be performed by another device or a group of devices separate from or including the modeling system 330, such as the classification system 310, data source 320, and/or the client device 340. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving a request to generate one or more predictions in a context related to a vehicle make and model combination (block 610). For example, the modeling system 330 (e.g., using processor 420, memory 430, input component 440, and/or communication component 460) may receive a request to generate one or more predictions in a context related to a vehicle make and model combination, as described above in connection with reference number 155 of FIG. 1C. As an example, the modeling system may receive a request to model a risk of default, to model an account level valuation, to model a deal structure risk, and/or to model a front-end limit for one or more loans or loan applications that use a vehicle make and model combination as collateral. In some implementations, the vehicle make and model combination is associated with a vehicle category. As an example, the modeling system may receive a request to generate one or more predictions related to a loan or loan application in which a vehicle make and model combination offered as collateral is classified as a premium sporty car in a luxury segment.

As further shown in FIG. 6, process 600 may include determining, among multiple vehicle indexes that are each associated with a respective modeling profile, a vehicle index associated with the vehicle make and model combination associated based on the vehicle category associated with the vehicle make and model combination (block 620). For example, the modeling system 330 (e.g., using processor 420 and/or memory 430) may determine, among multiple vehicle indexes that are each associated with a respective modeling profile, a vehicle index associated with the vehicle make and model combination associated based on the vehicle category associated with the vehicle make and model combination, as described above in connection with reference number 150 and 155 of FIG. 1C. As an example, a premium sporty car category in a luxury segment may map to a specific vehicle index.

As further shown in FIG. 6, process 600 may include providing, to a predictive model, a set of inputs that includes the vehicle index associated with the vehicle make and model combination (block 630). For example, the modeling system 330 (e.g., using processor 420 and/or memory 430) may provide, to a predictive model, a set of inputs that includes the vehicle index associated with the vehicle make and model combination, as described above in connection with reference number 155 of FIG. 1C and as further described above in connection with FIG. 2. As an example, the vehicle index may be used as an input along with one or more other inputs, such as credit bureau data, vehicle depreciation patterns, deal length, or the like.

As further shown in FIG. 6, process 600 may include obtaining, from the predictive model, an output that includes the one or more predictions based on the set of inputs that includes the vehicle index associated with the vehicle make and model combination (block 640). For example, the modeling system 330 (e.g., using processor 420 and/or memory 430) may obtain, from the predictive model, an output that includes the one or more predictions based on the set of inputs that includes the vehicle index associated with the vehicle make and model combination, as described above in connection with reference number 155 of FIG. 1C and as further described above in connection with FIG. 2. As an example, the modeling system may use machine learning techniques to generate the predictions, such as an account level valuation, a risk level, a front-end limit, or other predictions related to a modeling or data analytics use case associated with the vehicle make and model combination.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for vehicle categorization to assist model predictions, the system comprising:
one or more memories; and
one or more processors, communicatively coupled to the one or more memories, configured to:
obtain raw vehicle information that includes vehicle make and model combinations associated with one or more models;
define multiple vehicle segments that each include a set of vehicle makes based on the vehicle make and model combinations included in the raw vehicle information;
define, based on the vehicle make and model combinations included in the raw vehicle information, multiple vehicle categories based on subsets of the vehicle make and model combinations with similar attributes,
wherein the multiple vehicle categories are each associated with a unique identifier and a respective vehicle segment, of the multiple vehicle segments;
define multiple vehicle indexes that are each associated with a risk profile; and
store, in a data repository accessible to a system that uses the one or more models to generate one or more predictions based on an input vehicle make and model combination, information that associates each of the multiple vehicle indexes with one or more of the multiple vehicle categories.

2. The system of claim 1, wherein the one or more processors are further configured to:
assign each of the vehicle make and model combinations to one vehicle category, of the multiple vehicle categories.

3. The system of claim 1, wherein the one or more processors are further configured to:
execute one or more automated scripts configured to define one or more of the multiple vehicle segments or one or more of the multiple vehicle categories based on one or more rules.

4. The system of claim 1, wherein the one or more processors are further configured to:
receive, from a client device, one or more inputs to define one or more of the multiple vehicle segments or one or more of the multiple vehicle categories.

5. The system of claim 1, wherein the multiple vehicle indexes include at least one vehicle index associated with one or more vehicle categories in a first vehicle segment and one or more vehicle categories in a first vehicle segment.

6. The system of claim 1, wherein the one or more processors are further configured to:
filter the raw vehicle information to remove vehicle make and model combinations that are unavailable in a target geographic region.

7. The system of claim 1, wherein the one or more processors are further configured to:
filter the raw vehicle information to remove vehicle make and model combinations that have not been available in a target geographic region within a threshold time period.

8. The system of claim 1, wherein the one or more processors are further configured to:
execute one or more automated scripts configured to update one or more of the multiple vehicle segments or the multiple vehicle categories based on one or more new vehicle make and model combinations.

9. The system of claim 1, wherein the one or more processors are further configured to:
receive, from a client device, one or more inputs to update one or more of the multiple vehicle segments or the multiple vehicle categories based on one or more new vehicle make and model combinations.

10. A method for vehicle categorization to assist model predictions, comprising:
defining, by a classification system, multiple vehicle segments that each include a set of vehicle makes based on a set of vehicle make and model combinations;
defining, based on the set of vehicle make and model combinations, multiple vehicle categories based on subsets of the vehicle make and model combinations with similar attributes,
wherein the multiple vehicle categories are each associated with a unique identifier and a respective vehicle segment, of the multiple vehicle segments;
defining, by the classification system, multiple vehicle indexes that are each associated with a respective modeling profile; and
storing, by the classification system, information that associates each of the multiple vehicle indexes with one or more of the multiple vehicle categories.

11. The method of claim 10, further comprising:
assigning each of the vehicle make and model combinations to one vehicle category, of the multiple vehicle categories.

12. The method of claim 10, further comprising:
executing one or more automated scripts configured to define one or more of the multiple vehicle segments or one or more of the multiple vehicle categories based on one or more rules.

13. The method of claim 10, further comprising:
receiving, from a client device, one or more inputs to define one or more of the multiple vehicle segments or one or more of the multiple vehicle categories.

14. The method of claim 10, wherein the multiple vehicle indexes include at least one vehicle index associated with one or more vehicle categories in a first vehicle segment and one or more vehicle categories in a first vehicle segment.

15. The method of claim 10, further comprising:
obtaining raw vehicle information that includes the set of vehicle make and model combinations; and
filtering the raw vehicle information to remove vehicle make and model combinations that are unavailable in a target geographic region.

16. The method of claim 10, further comprising:
obtaining raw vehicle information that includes the set of vehicle make and model combinations; and
filtering the raw vehicle information to remove vehicle make and model combinations that have not been available in a target geographic region within a threshold time period.

17. The method of claim 10, further comprising:
executing one or more automated scripts configured to update one or more of the multiple vehicle segments or the multiple vehicle categories based on one or more new vehicle make and model combinations.

18. The method of claim 10, further comprising:
receiving, from a client device, one or more inputs to update one or more of the multiple vehicle segments or the multiple vehicle categories based on one or more new vehicle make and model combinations.

19. A non-transitory computer-readable medium storing a set of instructions, the set of instructions comprising:
one or more instructions that, when executed by one or more processors of a modeling system, cause the modeling system to:
receive a request to generate one or more predictions in a context related to a vehicle make and model combination,
wherein the vehicle make and model combination is associated with a vehicle category;
determine, among multiple vehicle indexes that are each associated with a respective modeling profile, a vehicle index associated with the vehicle make and model combination associated based on the vehicle category associated with the vehicle make and model combination;
provide, to a predictive model, a set of inputs that includes the vehicle index associated with the vehicle make and model combination; and
obtain, from the predictive model, an output that includes the one or more predictions based on the set of inputs that includes the vehicle index associated with the vehicle make and model combination.

20. The non-transitory computer-readable medium of claim 19, wherein the one or more predictions are related to one or more loans or loan applications in which a vehicle associated with the vehicle make and model combination is used as collateral.
